(19) United States
(12) Patent Application Publication
(10) Pub. No.: US 2003/0235111 A1
(43) Pub. Date: Dec. 25, 2003

(54) Noise reducing silo

(76) Inventors: Jerry C. Bishop, Cookeville, TN (US); Dale G. Klein, Livingston, TN (US)

Correspondence Address: KEIL & WEINKAUF, 1350 CONNECTICUT AVENUE, N.W., WASHINGTON, DC, 20036, US

(21) Appl. No.: 10/177,630

(22) Filed: Jun. 19, 2002

(51) Int. Cl. B01F 13/00

(52) U.S. Cl. 366/341; 222/564

(57) ABSTRACT

A silo stores bulk, particulate solids within a vertically oriented, elongated hollow body section. The lower end of the body section is joined to the top of a hollow bottom section and extends downwardly, tapering to a bottom of the bottom section. Solids are introduced into the silo through an inlet and withdrawn through an outlet port proximate the bottom of the bottom section. A perforated, hollow, flow-directing tube is disposed vertically within the body and bottom sections and secured within the silo, so that the bottom of the tube straddles the outlet port. The perforated tube substantially eliminates the formation of arches or bridging during withdrawal of particulate solids from the silo. Bursts of noise known as “silo honking” which accompany the collapse of such bridges are thereby eliminated. The noise reducing method and mechanism are readily applied during construction and operation of new silos. The present techniques are well suited for use in retrofitting existing silos to minimize noise emission during delivery of particulate solids stored therein.

### BACKGROUND OF THE INVENTION

1. Field of the Invention

This invention relates to a silo for the storage and delivery of particulate solids and the like; and more particularly, to method for constructing a silo that reduces the noise emitted during the delivery of particulate solids stored therein.

2. Description of the Prior Art

Silos are widely used in industrial and agricultural facilities for the storage of a broad range of bulk particulate solid materials. In agriculture silos are generally used to store grains or the like destined either to be consumed directly by farm animals or for later use in human food. Silos are also used in manufacturing facilities, most frequently for storing particulate raw materials that are feedstocks for subsequent processes. Generally stated, the use of a silo entails three key steps: filling with a pre-selected material, storage of the material for some period of time, and delivery of the stored material for further use. Silos employed in typical industrial processes are also frequently used for blending of multiple materials needed in a subsequent process. In virtually all silo configurations the main portion is elongated and vertically oriented and, most frequently is cylindrical. The bottom portion is conically narrowed to an opening having a size considerably smaller than that of the main portion of the silo. Material is normally introduced into the top of the silo by a mechanical conveyor or pneumatic delivery and removed through a reversibly openable port or orifice located at the narrowed silo bottom. Silos can be quite large, particularly those situated outdoors.

Although silos have long been used in the aforementioned applications, a number of problems persist that constrain their construction and use. One particularly notorious difficulty is noise. It has long been recognized that significant and sometimes highly objectionable sounds are associated with the flow of material in and through the silo. The sound levels in some cases reach levels that are harmful to the hearing of workers in close proximity to the silo. Frequently, the noise propagates beyond the confines of a facility, provoking complaints by neighbors in the surrounding area.

The noise from operating silos may take a number of forms. A particularly obnoxious form of such noise is frequently termed silo “honking” or “quacking.” Silo honking often takes the form of a sudden burst of high-level noise which may last a fraction of a second to a few seconds, followed by many seconds or minutes of relative quiet. Most industrial plants remain in operation twenty-four hours a day. Understandably, persons living in the vicinity of a facility may raise strenuous objection to the emission of noise, especially if it occurs during their normal sleeping hours. In some instances public pressure or governmental agencies may force steps to mitigate noise levels.

It is generally believed that honking arises from a non-uniform flow within the silo associated with various forms of stick-slip behavior. Periodically, as the silo is emptied, a large quantity of material therein may break away and slide, much like a snow avalanche. Various effects have been proposed as the proximate cause of the noise. The sudden rush of air accompanying the motion has been implicated by some, while others suggest that the noise comes from frictional forces between the sliding or falling material and the silo walls.

More particularly, it is normally regarded that there are two limiting regimes that describe particulate flow in a silo being emptied by removal of material through its bottom. During so-called “funnel flow,” only a portion of the total material in the silo is in motion toward the exit orifice. Funnel flow is characterized by substantial gradients in the velocity field within the emptying silo material, with some material being virtually at rest, while other material is moving rapidly. The flow pattern in the rapid region generally leads to the formation of “ratholes” in the flow pattern, characterized in that the portion of material in motion is virtually confined to a small, relatively cylindrical volume that quickly empties. Material surrounding the rathole then is likely to collapse into the rathole, thereby sustaining flow. Once formed, a rathole may persist for a considerable time as the path for material being withdrawn. However, ratholing generally results in other serious problems, that may include segregation of mixed particulate material, stagnation and aging of some portion of the silo contents, and the inability to sustain controllable, even flow.

The other extreme is generally termed “mass flow,” in which substantially the entire contents of the silo are in motion while material is being extracted, with little or no velocity gradient, except in the transition region in the silo bottom wherein continuity of flow dictates a substantial gradient.

The question of whether a given silo will empty predominantly by mass flow or funnel flow reflects a complex interplay between the geometry of the silo, particularly the design of the transition region between the bottom and the conical section extending to the exit orifice, and the characteristics of the stored medium, including (i) the distributions of particle size and shape and (ii) the type of material and the surface adhesion and friction characteristics thereof. Moisture content frequently has a strong influence on surface adhesion and flow properties, as is easily envisioned for examples such as the contrasting behavior of ordinary sand in either a moist or a fully dry state.

Prior art teaching concerning silo design has generally stressed the importance of achieving mass flow in preference to funnel flow as leading to uniformity and consistency of operation and amelioration of the aforementioned problems. However, a silo emptying particulate material in the mass flow regime is still vulnerable to certain forms of flow disruption also generally related to stick-slip behavior. One such difficulty is bridging, wherein the adhesion or interlocking of the stored particles results in formation of an arch-shaped “bridge” spanning an area of the interior of the silo. The area underneath may extend over at least a substantial portion of overall silo diameter and, in some cases, over the entire interior cross-section. Material below the arch continues to flow, creating a cavitation and an associated partial vacuum in the space below the arch. Eventually, the flow of material from beneath the arch may enlarge the cavitation to an extent that the support of the arch is no longer sufficient to support it. At this point, the arch collapses abruptly. A sudden flow of substantial amounts of material and a concomitant inrush of air act to re-establish an equilibrium configuration. It is believed that some combination of the rushing air and the sudden friction of material sliding rapidly along the silo wall gives rise to the honking phenomenon. The particular character of the sound is undoubtedly influenced by many factors of the construction materials and the configuration of piping and other structures in the silo and associated therewith.

A number of solutions have been proposed for eliminating the objectionable honking, including (i) modifying the overall structure or configuration of the silo, (ii) providing sound barriers or insulation, or (iii) changing the mode of operation of the silo. None of the known methods of mitigating the problems has been uniformly successful in eliminating the noise or even in reducing it to tolerable levels. In addition, many of the proposed solutions, such as use of a steeper emptying cone angle to promote mass flow or addition of external structure to the silo, are not practical for modifying existing structures. In most cases, they require additional room laterally or vertically to accommodate different external structure. Lateral clearance is often not available without reconfiguring other nearby equipment. Vertical clearance, especially underneath the silo, is often not available without either raising the entire silo structure or excavating beneath the silo. Even so, the level of the silo outlet often is constrained by other equipment with which the silo must be associated in an industrial process. Clearance above the silo may be unavailable. For an indoor installation, roof height may be limited. Aesthetic considerations or other building features may constrain the height of outdoor silos. Height modification may also be precluded by building codes and other regulatory limits. In short, the required modifications are at best cumbersome, time-consuming, and expensive to carry out and in many cases are simply not feasible.

Accordingly, there remains a need in the art for a silo that is capable of storing and dispensing bulk, particulate solids without producing the aforesaid honking noise. Also needed is a method for modifying existing silos to reduce honking and other objectionable noise with minimal disruption or reconfiguration of the silo and associated equipment.

### SUMMARY OF THE INVENTION

The present invention provides a silo for the storage and delivery of bulk, particulate solids with means for reducing objectionable noise during delivery of the material provided therein. The silo comprises: (i) a vertically oriented, elongated, hollow body section; (ii) a hollow bottom section joined at its top to the lower end of the body section and extending downwardly and tapering to a bottom of the bottom section; (iii) an inlet through which the solids are introduced into the silo; (iv) an outlet port proximate the bottom of the bottom section through which the solids are withdrawn from the silo; and (v) a perforated, hollow, flow-directing tube disposed vertically within the body and bottom sections and secured within the silo, the bottom of the tube straddling the outlet port. Advantageously, the provision of the perforated tube substantially eliminates the formation of arches or bridging in the particulate solids stored in the silo, which are especially prevalent near the joint connecting the body and bottom sections. The collapse of such a bridging is a manifestation of stick-slip behavior and generally results in the emission of a sudden burst of noise often termed “silo honking.” Such noise frequently reaches a sound level that is sufficiently loud to require mitigation, to prevent hearing impairment of workers in proximity to the silo and to reduce environmental impact on neighbors in the vicinity of the facility operating the silo.

There is also provided a method of retrofitting an existing silo to reduce the emission of noise during the silo's operation. The method advantageously does not require additional room either laterally or vertically to accommodate different external structure. Moreover, the method does not entail external modification of the silo. The method comprises provision of a perforated, flow-directing tube disposed vertically within the body and bottom sections of the silo. The tube is secured straddling the outlet port of the silo. At least a preponderance of the particulate solids withdrawn from the silo through its outlet port is supplied through the tube.

There is also provided a method of reducing the noise produced during the withdrawal of bulk, particulate solids stored in a silo. The method comprises: (i) providing a perforated, flow-directing tube disposed vertically within the body and bottom sections of the silo, the tube being secured straddling the bottom outlet port of the silo and (ii) withdrawing the particulate solids from the silo through the outlet port at a pre-selected rate, with at least a preponderance of the particulate solids being supplied through the flow-directing tube.

Advantageously, the present silo and the method of operation thereof solve a long-standing problem with silos, namely, the highly objectionable emission of noise resulting from irregular flow during the withdrawal of material stored in the silo. The method is conveniently and inexpensively implemented at low cost, since it may be employed to retrofit an existing silo without need for external reconfiguration.

### BRIEF DESCRIPTION OF THE DRAWINGS

The invention will be more fully understood and further advantages will become apparent when reference is had to the following detailed description of the various embodiments of the invention and the accompanying drawings, wherein like reference numeral denote similar elements throughout the several views, in which:

FIG. 1 is a partially cutaway perspective view of a prior art silo and ancillary equipment; and

FIG. 2 is a partially cutaway perspective view of a silo of the invention.

### DETAILED DESCRIPTION OF THE PREFERRED EMBODIMENTS

The present invention provides a silo for the storage, blending, and delivery of bulk, solid particulate materials. Advantageously, the structure of the silo results in a significant reduction in noise emitted during the delivery of its contents. Further provided is a method for constructing and operating a silo having a reduced propensity to honk or emit otherwise objectionable noise during operation thereof. The construction method is particularly adapted for simply and conveniently retrofitting an existing silo without the need for major external modifications thereof.

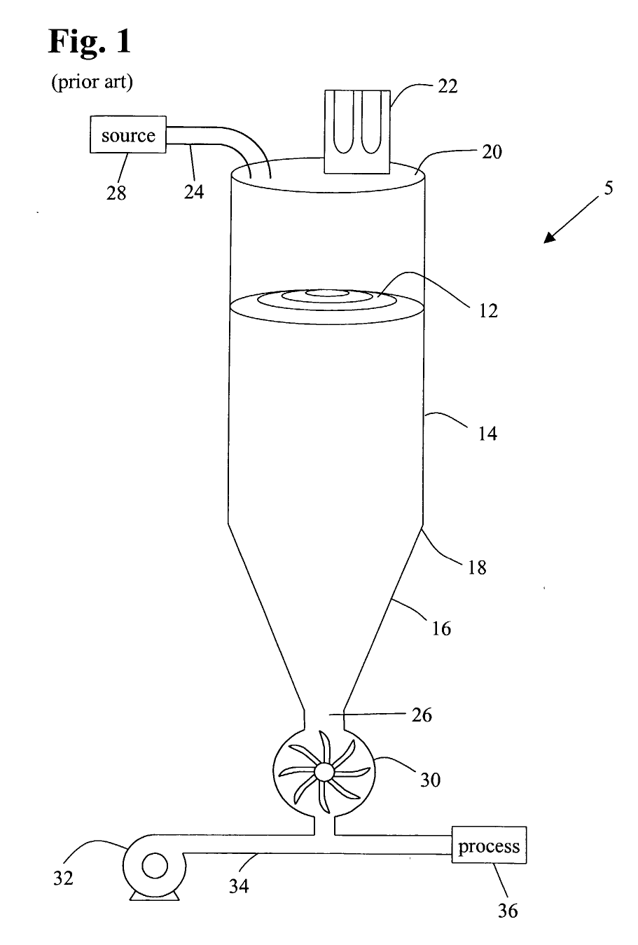

Referring now to FIG. 1 there is depicted a prior art silo 5 for storing and dispensing bulk, particulate solid matter 12. Further depicted are exemplary means by which the silo is associated with a supply of the material to be stored therein and delivered as feedstock to an industrial process 36. The silo 5 is of conventional structure and comprises a vertically oriented, hollow, elongated cylindrical storage body section 14, and a hollow, tapered bottom section 16 joined to the lower end 18 of the body section 14. Preferably, the silo 5 further comprises a top cover 20 protecting the contents. It is also preferred that a means be provided to allow equalization of air pressure inside and outside the silo without dispersing product or dust. A bag house air purge system 22 is conveniently used to carry out this function. Material from a source 28 is introduced to the silo through a tube 24 that empties at or near the top of the silo. An outlet port 26 at the bottom of the bottom section 16 of the silo allows the contents, which are fed by gravity flow, to be withdrawn and dispensed for further use. The dispensed material may then be conveyed by known means to another location for processing or other desired action. In the depicted embodiment, the silo's contents are dispensed by metering valve 30 and conveyed by flow of air from blower 32 in supply tube 34 toward process 36.

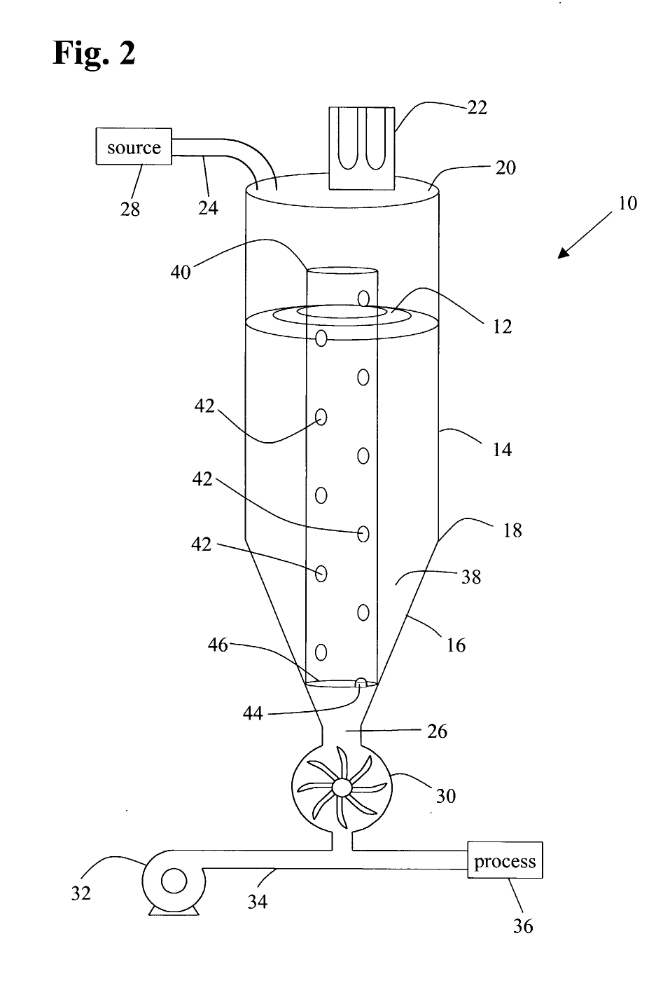

FIG. 2 depicts a silo 10 of the invention constructed by retrofitting a conventional silo similar in form to that depicted by FIG. 1. In the preferred embodiment shown, the body section 14 is cylindrical and the tapered bottom section 16 is frustoconical. The retrofitting further provides a vertically-oriented, perforated, flow-directing tube 40 disposed within the body and bottom sections of the silo 10. The tube 40 is secured with its bottom adjacent the bottom section 16 of the silo at a central location straddling the outlet port 26. Additional support (not shown) of any conventional type may be provided as needed to secure the tube in position. As a result of the placement of the flow-directing tube 40, at least a preponderance of the material being withdrawn from the silo 10 enters tube 40 through any of a plurality of perforations 42 passes through the tube 40. Some material may come directly from the annular space 38 between the exterior of the tube 40 and the interior walls of the silo 10. It is preferred that the tube 40 not be completely sealed to the interior surface of the bottom section 16 of the silo 10. If the tube 40 is completely so sealed, then a dead zone is created at the bottom of the annular space 38 in which some material may be trapped irremovably. The presence of at least one passage 44 allowing a limited proportion of material to bypass the flow-directing tube 44 is also preferred in that it enhances the ability of the silo to provide continued mixing of the contents during filling and withdrawal. Preferably the tube 40 is cylindrical and oriented coaxially with the overall silo structure. In addition, it is preferred that tube 40 have a plurality of perforating holes 42 that are substantially identical in size and shape and that the holes 42 be disposed evenly around the periphery of tube 40 and equally spaced along its length.

Various means are suited for supporting the silo of the invention. In some embodiments the silo is mounted on stilts attached above the tapered bottom section, while in other embodiments an optional skirt section attached to the body section substantially encloses the tapered bottom section and provides support for the silo structure. Other suitable means of silo support will be apparent to one skilled in the art.

Numerous materials may be used in the construction of the silo of the invention, including both metals and polymers. Aluminum is preferred for silos in which weight is a consideration. In some cases the material to be stored is somewhat corrosive or caustic, in which case a more inert material such as stainless steel is preferred. Moreover, the interior surface of the silo may optionally be provided with a coating of glass or a polymer. It is further preferable that the interior surface of the silo be hard and smooth to eliminate abrasion, wear, and friction stemming from material sliding along the surface.

A wide variety of agricultural and industrial materials can conveniently be stored and dispensed by the silo of the invention. Generally stated, the materials are provided in free-flowing, particulate form. As is known in the art of handling particulate material, the delivery of material onto a flat surface generally results in a pile having an approximately conical top surface. The angle of the cone that naturally forms is known as the angle of repose. The value of this angle is a consequence of the surface properties of the material, including the coefficient of friction, and also the morphology of the individual particles. Environmental factors such as moisture content often have a profound effect on flow properties and thus on the angle of repose. The low properties of materials are frequently characterized by an empirically determined value of the angle of repose.

It has been found that prior art silos are particularly vulnerable to honking when used to store and deliver certain polymer resins in pellet form. Advantageously, the present silo is useful for handling such materials without honking or noise production. Materials that may be handled include polymer resins, grains such as corn and soybeans, coal, aggregates and other construction materials, and the like. The present silo is especially preferred for storing and dispensing polymer resins, including nylon 6, nylon 6/6, nylon 6/6/6, polyester, polypropylene, polyvinylchloride (PVC), polystyrene, polyethylene, polycarbonate, and polymethylmethacrylate (PMMA). Previous silos have been especially prone to honking when used with these materials.

The preferred size and shape of the components of the invention is dependent on a large number of factors, including the volume of storage desired, the flow behavior of the material stored, and the rates of required input and output. Silos for industrial components may in some cases be 100 or more feet (30 m) high and 10 to 20 feet (3-6 m) in diameter. Although generally cylindrical silos convey a number of advantages in terms of maximizing storage capacity and providing structural strength and integrity, other shapes such as pyramidal are also known and considered within the scope of the invention. The tapered bottom section preferably has a cone angle ranging from about 45° to 75° from horizontal.

The flow-directing tube used in the construction of the silo of the invention is preferably a right circular cylinder, open at its top and coaxially aligned with and secured to, the silo's bottom section. A plurality of holes is provided in the elongated cylindrical surface of the tubular section. Preferably the holes are substantially identical in size and shape and are equally spaced around the periphery of the tube and along its length. The tube may be constructed using any material having sufficient strength and compatibility with the silo contents. Preferably the tube is composed of the same material that is used for the silo and given the same surface finish or coating as well. Aluminum and stainless steel are especially preferred materials for the tube.

The flow-directing tube is sized in accordance with the nature of the material to be delivered and the overall sizing of the silo and its outlet port. It is preferred that the transverse cross-sectional area of the tube be no smaller than the area of the silo outlet port and no larger than about 40% of the transverse area of the silo itself. Too small a tube undesirably restricts the flow rate through the tube, starving the outlet port. If the tube is too large, then the desired reduction in honking and other silo noise is not sufficient. More preferably, the flow directing tube has a diameter ranging from about 20 to 40% of the diameter of the body section. It will be appreciated by one skilled in the silo art that the sizing of the tube may be modified to accommodate the characteristics of different materials appointed to be handled by the silo.

The tube preferably extends from an attachment to the interior surface of the bottom section to at least 60 to 90% of the height of the silo. It is frequently found that during withdrawal of material from the silo, a hollow, generally conically shaped depression forms in material near the center of the silo. This hollow shape approximates an inverse of the conical shape similar to the positive shape formed during silo filling. The hollow cone is characterized by formation of a similar angle of repose. In order to prevent the ratholing that may result from formation of the conical depression, it is further preferred that the flow-directing tube extend above the possible level of the vertex of this depression. That is to say, the tube preferably extends vertically at least to a height of the maximum silo fill, less double the height of a cone having a base diameter of the silo and a cone angle equal to the angle of repose of the selected material. With this arrangement, the flow directing tube is enabled to function, whatever the internal level of material within the silo.

The perforations of the flow-directing tube allow replenishment of the material being withdrawn from the tube through the bottom outlet port of the silo. As the tube empties, it is refilled by the flow of material through the perforations from the generally annular region between the exterior of the tube and the interior sidewalls of the silo. Each individual hole in the tube must be of a size that does not become clogged or otherwise impeded. The total area of the holes must be sufficient to allow the material in the tube to be replenished at least as rapidly as material is being withdrawn. Too large a total area will negate the flow-directing characteristic of the tube, so that noise reduction is not accomplished. Preferably, the holes have a diameter ranging from about 3 to 10 inches (7.5-30 cm) and a center to center spacing ranging from about 1 to 3 feet (30-90 cm), depending on the size of the tube and silo.

In another aspect the present invention provides a method of reducing the noise produced during the operation of a silo for the storage and delivery of bulk, particulate solids. The method comprises: (i) providing a perforated, flow-directing tube disposed vertically within the body and bottom sections of the silo, the tube being secured straddling the bottom outlet port of the silo and (ii) withdrawing the particulate solids from the silo through the outlet port at a pre-selected rate, with at least a preponderance of the particulate solids being supplied through the flow-directing tube.

In still another aspect the present invention provides a method of retrofitting an existing silo to reduce the noise produced during operation thereof. The silo comprises a vertically oriented, hollow, elongated body section and a hollow, bottom section joined at its top to the body section and extending downwardly and tapering to a bottom of the bottom section. The modification comprises provision of an elongated, flow-directing tube preferably extending coaxially within the silo between the bottom section and to substantially the full height of the storage body. Advantageously the modification can be carried out without external modification of the silo. The exterior structure need not be modified in any way that would compromise its structural integrity, change its aesthetic appearance, or alter it irreversibly. Since the required changes are internal, there is no need to provide additional space for the silo either peripherally or vertically. By way of contrast, many previous methods of silo noise abatement have entailed major changes. In some cases external devices such as added piping have been suggested, for which space may not be available without shifting the overall location of the silo. In other cases, structural modifications have been proposed, notably including changes in the opening angle or length of the conical bottom section. These alterations frequently require change in the overall elevation of the silo either to accommodate additional need for ground clearance or to maintain a delivery level commensurate with other systems in an overall plant. Any of these changes generally entail very significant construction costs and are difficult to undo or further modify, notwithstanding the poor efficacy sometimes achieved with these prior art methods.

In a further aspect, the present invention provides a method of blending a plurality of bulk, particulate solids. Such mixing/blending operations are frequently required in industrial processing. The efficiency of mixing is further enhanced by provision of closed-circuit recirculating means that extract a portion of material from the bottom of the silo, convey it to the top of the silo, and return it to the overall stock. The recirculating means frequently comprises (i) recirculating piping or like conduit means connecting the outlet port or an auxiliary port also located near the silo bottom and the top of the silo and (ii) pneumatic or other suitable means for conveying the flow of material through the recirculating piping. The piping may be located external to the tank or may be located substantially coaxially inside the flow-directing tube and extending to the silo top. It is also preferred for further enhancing the mixing function of the present invention that the area of perforation of the flow directing tube be allocated over a large number of small holes, rather than a small number of large holes.

The following examples are presented to provide a more complete understanding of the invention. The specific techniques, conditions, materials, proportions and reported data set forth to illustrate the principles and practice of the invention are exemplary and should not be construed as limiting the scope of the invention.

### COMPARATIVE EXAMPLE 1

### Characterization of Silo Honking

An existing silo of conventional design, used to store and dispense resin pellets for an industrial process, was selected for noise testing. The silo was about 60 feet (18 m) tall overall and 12 feet (3.6 m) in diameter, having a cylindrical center section about 50 feet (15 m) long and a frustoconical bottom section with a cone angle of 60° tapering to an outlet port about one foot (30 cm) in diameter. The center section of the silo was constructed of aluminum material, while the bottom section was stainless steel. The interior of the silo was designed to promote smooth flow of product and did not include any further internal structure appointed to impede or otherwise direct the flow of material to the outlet port.

The silo was filled pneumatically to about 80% capacity with nylon 6 resin in the form of substantially identical cylindrical pellets having a diameter of about ⅛ inch (3 mm) and a length of about ⅛ inch (3 mm). A MetroSonics model 3080 integrating, recording sound level meter was placed in the vicinity of the silo. The meter was capable of recording averaged sound intensity with a 1 second time constant in accordance with OSHA standards and was calibrated in accordance with the manufacturer's established procedure. Material was dispensed from the silo in batches into a hopper removably mounted on the silo output port. Each batch had a 1 to 5 minute duration, with material being delivered at a rate of about 5000 lb/hr (2300 kg/hr). The material was then conveyed pneumatically to a receiving hopper for subsequent delivery to a processing system for extrusion into selected shapes.

The subject silo was known from past experience to honk periodically during extraction of product under the conditions described. A trial was carried out in which sound level data were logged by the recorder at a location within the silo. The data were subsequently analyzed and found to reveal a typical background sound level of about 60 dBA, which rose to about 100 dBA during the period of activation of the pneumatic conveyance system. However, the system also repeatedly recorded noise spikes of 5-10 sec duration that occurred a few seconds after the conveyance system was turned off. Within the silo, the noise level in that spike rose from the 60-65 dBA ambient to at least 80-85 dBA. Observers outside the silo confirmed the presence of these noise spikes, which were at a much higher intensity and matched the pattern of occurrence of honking known from previous use of this silo system in the course of conventional operation of the facility where it was sited.

### COMPARATIVE EXAMPLE 2

### Fluidization of the Silo Contents

The silo used for the tests set forth in Comparative Example 1 was modified to provide a flow of compressed air to fluidize the pellet charge and modify its flow characteristics. Six metal pipes, each about 4 ft (1.2 m) long and 1 inch (2.5 cm) in diameter and having a large number of holes therein, were disposed in the interior of the silo. The pipes were located horizontally at about the top of the bottom section and were oriented radially perpendicular to the silo's vertical center axis. Compressed air provided by a 200 HP diesel-driven air compressor was supplied to the pipes, whereby air was allowed to flow into and through the pellet charge and fluidize it. The silo was otherwise operated as set forth in Comparative Example 1. A variety of airflow rates were tried, but silo honking persisted at each flow rate.

### COMPARATIVE EXAMPLE 3

### Modification of the Interior Surface of a Silo

The silo used for the tests set forth in Comparative Example 1 was modified by the provision of a liner composed of Teflon substantially covering the conical bottom section. The silo was operated as set forth in Comparative Example 1. Honking was observed at intervals and with sound intensity comparable to that recorded in Comparative Example 1, demonstrating that the modification of the surface characteristic of the bottom section of the silo by provision of the Teflon liner was not effective in reducing honking.

### COMPARATIVE EXAMPLE 4

### Modification of the Interior Structure of a Silo

The silo used for the tests set forth in Comparative Example 1 was modified by addition of a supplemental inner cone appointed to alter the flow pattern proximate the outlet port of the silo. The inner cone had a top diameter of 35.5 inches (90 cm), a height of 48.75 inches (124 cm), and a cone angle of 15° from vertical. It was supported by gussets extending radially outward from the cone and was placed proximate the outlet of the bottom portion of the silo. It was postulated that the higher cone angle would enhance flow at the silo bottom. The silo was operated otherwise as set forth in Comparative Example 1. Honking was observed at intervals and with sound intensity comparable to that recorded in Comparative Example 1, demonstrating that the modification of the bottom section of the silo by addition of the supplemental inner cone structure was not efficacious in reducing honking.

### EXAMPLE 5

### Laboratory Simulation of Operating Silo

A laboratory simulation of the effect of a flow directing tube in a full-scale industrial system was carried out with a cylindrical fiber drum about 36 inches (90 cm) in height and 24 inches (60 cm) in diameter. A flow-directing cylindrical tube composed of stainless steel pipe 4 inches (10 cm) in diameter and substantially the full height of the fiber drum was placed in the center of the fiber drum. The tube had a series of 2 inch (5 cm) diameter holes every foot (30 cm) rotated 90 degrees every foot (30 cm) in its cylindrical surface. A 4 inch diameter (10 cm) hole was placed in the center of the bottom of the drum through which the flow directing tube was passed. Pelletized nylon 6 of the type used in the trials of Comparative Examples 1-3 was employed for the trial. The drum was filled to about one foot (30 cm) height with a first layer of green pellets, then a second layer of white pellets of the same size was added to substantially fill the drum. The pellet flow through the bottom opening was observed as being unimpeded. A sample was collected and found to contain both colors of pellets with excellent mixing, demonstrating the efficacy of the flow-directing tube in causing mixing of the contents being delivered.

### EXAMPLE 6

### Testing of a Pilot-Scale Industrial Silo with Center Tube

A series of tests denoted as Trials 6A to 6F were carried out using a Mixaco Mixing Bowl fitted with various flow-directing center tubes. The bowl was constructed of stainless steel and had a cylindrical top section 35 inches (90 cm) in diameter and a height of 20 inches (50 cm) and a frustoconical bottom section that tapered with a cone angle of about 63° to a bottom outlet port having a 6 inch (15 cm) diameter butterfly valve. A series of cylindrical aluminum flow directing tubes having various lengths and diameters were fabricated. The tubes were perforated through the cylindrical surface thereof by a series of holes of a pre-selected diameter located at levels along the tube length spaced by pre-selected equal intervals. Two holes were placed on diametrically opposite sides of the tube at each of the levels. The holes at the adjacent preselected levels were located alternately at 90° and 270° from the holes at the preceding and subsequent levels. Each tube was fixed in turn in a vertical position coaxial with the mixing bowl and with the tube bottom straddling the bowl's outlet port.

Flow trials using each of the configurations were carried out with nylon 6 resin pellets about ⅛ inch (3 mm) in diameter and ⅛ inch (3 mm) long. The mixing was characterized by filling the top and bottom halves of the bowl with pellets that were substantially identical in shape and surface character but of different colors. The test apparatus was emptied through the bottom port. Samples of the delivered material comprising at least 2000 pellets were collected at several stages during the emptying. The number of pellets of each color was determined at each stage, the ratio being used as a measure of the efficacy of mixing. The flow characteristic of each configuration was also determined.

Table I below sets forth the results of the tests carried out.

TABLE 1
Pilot-Scale Flow Test Results

| | Trial | Trial | Trial | Trial | Trial | Trial |
|---|---|---|---|---|---|---|
| | 6A | 6B | 6C | 6D | 6E | 6F |
| Pipe Diameter | 6 | 6 | 10 | 10 | 10 | 10 |
| (in) | | | | | | |
| Hole Diameter | 0.5 | 1.25 | 0.75 | 1.25 | 2 | 2 |
| (in) | | | | | | |
| Hole Spacing | 10.5 | 10.5 | 10.5 | 5.5 | 5.5 | 5.5 |
| (in, center to | | | | | | |
| center) | | | | | | |
| Pipe Height (in) | 36 | 36 | 36 | 36 | 36 | 18 |
| Pellet Flow | none | Poor | none | good | excellent | excellent |
| mixing - high | N/A | N/A | N/A | 1:1.6 | 1:0.5 | 1:0.3 |
| mixing - middle | N/A | 1:0.1 | N/A | N/A | 1:8.9 | 1:0.2 |
| mixing - low | N/A | N/A | N/A | 1:0.2 | 1:7.8 | 1:6.2 |
| mixing - very low | N/A | N/A | N/A | N/A | 0: 2294 | N/A |

The results of the tests depicted in Table I indicate that proper flow and efficacious mixing is achieved by suitable sizing of the perforated, flow-directing center tube. Flow was categorized as either poor (insufficient to satisfy a required flow rate), good (able to satisfy a required flow rate), or excellent (more than adequate to supply desired flow rate). In Trial 6F, the central tube used did not extend to the full height of the mixing bowl, so that some flow along the sides of the mixing bowl was observed until the pellet level dropped below the top of the center tube, after which excellent flow, comparable to that demonstrated in trial 6E, was seen. This condition would give rise in some cases to honking during the withdrawal of material from a full-scale industrial silo. After the level dropped enough to expose the top of the center tube, flow occurred predominantly through the center tube. It is therefore preferred that the flow-directing tube extend substantially the full height of a silo. A perforation hole diameter less than about 1.25 inch (3 cm) was seen to be insufficient to allow pellet flow, while 2 inch (5 cm) holes provided excellent flow. Mixing was observed at several stages of emptying the apparatus, specifically with the bowl nearly full, about half-way full, about one quarter full, and nearly empty, as set forth in Table I. In some cases, analysis of the extent of mixing of contents initially in the top and bottom half of the bowl charge was carried out, using the aforementioned sampling procedure. It may be seen that mixing is best promoted by use of perforating holes of intermediate diameter.

The results set forth indicate the importance of selection and placement of the holes perforating the flow-directing tube in achieving satisfactory flow patterns that substantially or completely eliminate the problem of silo honking during the withdrawal of material from full-scale industrial silos.

### EXAMPLE 7

### Operation of an Industrial Silo with Center Tube

The silo used for the tests set forth in Comparative Example 1 was modified by addition of a perforated, flow-directing tube. The tube was fabricated of 0.25 inch (6 mm) thick aluminum and was cylindrical with a diameter of about 3 feet (90 cm) and a length of about 40 feet (12 m). A series of 6 inch (15 cm) diameter holes was provided in the cylindrical surface at 2 foot (60 cm) intervals. Two 6 inch (15 cm) holes were placed on diametrically opposite sides of the tube at each level. The holes at the adjacent two-foot (60 cm) levels were located alternately at 90° and 270° from the holes at the preceding and subsequent levels. The tube was mounted coaxially in the silo, extending upwardly from the conical bottom section. Two half-round holes were drilled into the surface of the pipe at its bottom to allow material stored in the silo to be fully drained. However, the clearance was small enough that the flow of material during normal withdrawal from the silo was predominantly derived from material present in the flow-directing tube.

The silo was operated in accordance with the filling and withdrawal rates set forth in Comparative Example 1. It was observed that material entered the flow-directing tube through the peripheral holes therein. Despite prolonged operation and monitoring of the silo under a wide range of environmental conditions, honking was not observed, establishing the efficacy of the flow-directing tube in altering the flow pattern to substantially eliminate the bridging phenomena that gave rise to the honking patterns that occurred in Comparative Examples 1-3.

Having thus described the invention in rather full detail, it will be understood that such detail need not be strictly adhered to but that various changes and modifications may suggest themselves to one skilled in the art, all falling within the scope of the present invention as defined by the subjoined claims.

1. A silo for bulk, particulate solids, comprising:
a) a vertically oriented, elongated, hollow body section;
b) a hollow bottom section joined at its top to the lower end of said body section and extending downwardly and tapering to a bottom of said bottom section;
c) an inlet through which said solids are introduced into said silo;
d) an outlet port proximate said bottom of said bottom section through which said solids are withdrawn from said silo; and
e) a perforated, hollow, flow-directing tube having a top and a bottom, said tube being disposed vertically within said body and bottom sections and secured within said silo with said bottom of said tube straddling said outlet port.

2. A silo as recited by claim 1, wherein said body section is cylindrical.

3. A silo as recited by claim 1, wherein said tapered bottom section is frustoconical.

4. A silo as recited by claim 3, wherein said frustoconical tapered bottom section has a cone angle ranging from about 45° to 75° from horizontal.

5. A silo as recited by claim 1, wherein said perforated, flow-directing tube is cylindrical.

6. A silo as recited by claim 1, wherein said perforated, flow-directing tube is composed of aluminum.

7. A silo as recited by claim 1, wherein said perforated, flow-directing tube is composed of stainless steel.

8. A silo as recited by claim 1, wherein said perforated, flow-directing tube has a diameter of at least about 20% of the diameter of said body section.

9. A silo as recited by claim 1, wherein said perforated, flow-directing tube has a diameter of less than about 40% of the diameter of said body section.

10. A silo as recited by claim 1, wherein said perforated, flow-directing tube has a diameter ranging from about 20 to 40% of the diameter of said body section.

11. A silo as recited by claim 1, wherein said perforated, flow-directing tube has a length ranging from about 60% to 90% of the height of said silo.

12. A silo as recited by claim 1, wherein said perforations of said flow-directing tube have a diameter ranging from about 3 to 10 inches (7.5-25 cm).

13. A silo as recited by claim 1, wherein said perforations have substantially identical size and shape and are evenly spaced along said flow-directing tube.

14. A silo as recited by claim 1, further comprising recirculating means for blending bulk, particulate solids present in said silo to improve the mixing thereof.

15. A method of retrofitting a silo for bulk, particulate solids to limit the noise produced during the operation thereof, the silo comprising:
a) a vertically oriented, elongated hollow body section;
b) a hollow bottom section joined at its top to the lower end of said body section and extending downwardly and tapering to a bottom of said bottom section;
c) an inlet through which said solids are introduced into said silo; and
d) an outlet port proximate said bottom of said bottom section through which said solids are withdrawn from said silo;
and said method comprising the steps of:
e) positioning a perforated, flow-directing tube vertically within said body and bottom sections, said tube having a top and a bottom;
f) securing said tube within said silo with said bottom straddling said outlet port;
whereby said tube supplies at least a preponderance of particulate solids withdrawn from said silo through said outlet port.

16. A method of reducing the noise produced during the withdrawal of bulk, particulate solids stored in a silo, the silo comprising:
a) a vertically oriented, elongated hollow body section;
b) a hollow bottom section joined at its top to the lower end of said body section and extending downwardly and tapering to a bottom of said bottom section;
c) an inlet through which said solids are introduced into said silo; and
d) an outlet port proximate said bottom of said bottom section through which said solids are withdrawn from said silo;
and the method comprising the steps of:
e) positioning a perforated, flow-directing tube vertically within said body and bottom sections, said tube having a top and a bottom;
f) securing said tube within said silo with said bottom of said tube straddling said outlet port; and
g) withdrawing said particulate solids from said silo through said outlet port at a pre-selected rate, at least a preponderance of said particulate solids being supplied through said flow-directing tube.

17. A method as recited by claim 16, wherein said particulate solids are composed of at least one member selected from the group consisting nylon 6, nylon 6/6, nylon 6/6/6, polyester, polypropylene, PVC, polystyrene, polyethylene, polycarbonate, and PMMA.

18. A method as recited by claim 16, wherein said particulate solids are composed of pellets of nylon 6 resin.

19. In a silo for storage and delivery of bulk, particulate solids, having a vertically oriented, elongated hollow body section, a hollow bottom section joined at its top to the lower end of said body section and extending downwardly and tapering to a bottom of said bottom section, an inlet through which said solids are introduced into said silo and an outlet port proximate said bottom of said bottom section through which said solids are withdrawn from said silo, the improvement wherein said silo additionally comprises:
a perforated, flow-directing central tube having a top and a bottom, and being disposed vertically within said body and bottom sections, said tube being secured within said silo with said bottom straddling said outlet port, to supply at least a preponderance of the particulate solids withdrawn from said silo through said outlet port.
